(19) United States
(12) Patent Application Publication
(10) Pub. No.: US 2022/0180903 A1
(43) Pub. Date: Jun. 9, 2022

(54) System And Method Of Duet Video Creating And Advertising

(71) Applicants: Zuoliang Chen, San Francisco, CA (US); Anissa Chen, San Francisco, CA (US); Andy Chen, San Francisco, CA (US)

(72) Inventors: Zuoliang Chen, San Francisco, CA (US); Anissa Chen, San Francisco, CA (US); Andy Chen, San Francisco, CA (US)

(21) Appl. No.: 17/678,367

(22) Filed: Feb. 23, 2022

(51) Int. Cl. G11B 27/036; H04N 5/92; H04N 5/232; H04N 5/265; G06Q 30/02

(52) U.S. Cl. CPC G11B 27/036; H04N 5/9205; H04N 5/232935; G06F 3/0481; H04N 5/265; G06Q 30/0277; H04N 5/232939

(57) ABSTRACT

The system and method of duet video creating and advertising of the present invention is a digital platform that provides duet templates for video creators to create duet videos, each duet template is associated with a right template clip selection button, a left template clip selection button, an invitation button and a sponsor button, such that a creator can use the right or left template clip selection button to choose to act as the right or left template clip, use the invitation button to invite someone to create a duet video together, and an advertiser can use the sponsor button to sponsor a template and embed ad to the template, such that a duet video created from a duet template will carry the same embedded ad, and the embedded ad can be shared together with the duet video to other video or social platforms. In a preferred embodiment, the system of the present invention comprising at least one digital device, a duet video app and a database, the duet video app further composing a template displaying module, a duet clip creating module, a duet video creating module, an invitation duet video creating module, a sponsor ad embedding module, a template creating module, a template uploading module, and a duet video sharing module. The present invention gives duet video creators the option. to watch a demo, choose a role, react to a counterpart, and select someone to duet with, and it provides a method for advertisers to use duet videos to promote their brands, products or service at a cost effective way.

### RELATED APPLICATION

This application claims priority from U.S. Provisional Patent Application No. 63/157,121, filed on Mar. 5, 2021, entitled System and Method of Duet Video Making.

This application. also claims priority from U.S. Provisional Patent Application No. 63/254,734, filed on Oct. 12, 2021, entitled System and Method of Duet Video Advertising.

### FIELD OF THE INVENTION

The present invention is related to a system and method, more specifically a platform that provides duet templates for video creators to create duet videos easily, as well as to provide a method for advertisers to embed their ads to these duet templates, such that a duet video created from a duet template will carry the same embedded ad, and the embedded ad can be shared together with the duet video to other video or social platforms.

### BACKGROUND

As short videos become more and more popular, the demand for high quality short video contents increase substantially as well, in view of this, short video platforms such as TikTok introduced its biggest video creating feature—duets. However, such duet video feature that built into a short video app is far from satisfactory and has the following problems:

1. Since the duet video creating process is start from an original video clip, a creator can only duet with the original clip, with no option to choose a role or to select someone to duet with, and can only produce one duet video with the original clip each time.

2. It provides no way for duet video creators to monetize their duet videos directly.

3. It provides no ways for advertisers to use duet videos to promote their brands, products or service at a cost effective way.

Therefore, there is a strong need for a duet video platform that enables duet video creators to create duet video easily, as well as for advertisers to use duet video to promote their brands, products or service at a cost effective way.

### Advantages of Present Invention

A workable app of the present invention has been successfully built and tested, short video creators like it because it enables them to create duet videos very easily and provides them a way to monetize their followership. The present invention has the following advantages:

1. The duet video creating process is started from a duet template instead of from a video clip, it gives creators the option to watch a demo, choose a role, react to a counterpart, and select someone to duet with.

2. Creators can get multiple duet videos by creating only one creator clip.

3. It provides a ways for advertisers to use duet videos to promote their brands, products or service at a cost effective way.

4. It provides a ways for duet video creators to monetize their followership directly by sharing their duet videos.

Further objects and advantages are to provide a system and method, more specifically a platform that provides duet templates for short video creators to create duet videos easily, as well as to provide a method for advertisers to embed their ads to these duet templates, such that a duet video created from a duet template will carry the same embedded ad, and then the embedded ad can be shared together with the duet videos to other video or social platforms.

### Description of the Prior Art

U.S. Pat. No. 9,583,142B1 granted to Jun Zhu, Bingjun Zhou, Luyu Yang on Feb. 28, 2017 disclose a duet video making method which include a module for creating a duet, or use of the same. In this prior art, a user does not have to be in the same place as another user to create a musical together. In some embodiments, a software module is configured to present an interface allowing a user to create a duet video, the interface comprising tools allowing the user to select a pre-existing lip-sync video, wherein the pre-existing lip-sync video automatically integrated with captured video to create a new duet video.

The problem with the duet video making method of this prior art is that it's duet video creating process is start from a pre-existing video clip, a user can only duet with that particular pre-existing video clip, with no option to choose a role or to select someone to duet with, and can only produce one duet video with the pre-existing clip each time. Therefore, the duet video production and creativity are greatly limited by this prior art.

### BRIEF DESCRIPTION OF DRAWINGS

FIG. 1 illustrates the flowchart of the present invention showing how a creator creates a duet video from a template clip selection button.

FIG. 2 illustrates the flowchart of the present invention showing how a creator creates a duet video from a template invitation button.

FIG. 3 illustrates the flowchart of the present invention showing how a template creator creates a template.

FIG. 4 illustrates the flowchart of the present invention showing how an advertiser sponsor a template and embed an ad to the template.

FIG. 5 illustrates a duet video displayed on a smart phone.

FIG. 6 illustrates a duet template displayed on a smart phone.

### REFERENCE NUMERALS IN DRAWINGS

1 System of the present invention
11 App server
12 Duet video App
121 Template displaying module
122 Duet clip creating module
123 Duet video creating module
124 Duet video sharing module
125 Invitation duet video creating module
126 Template creating module
127 Sponsor ad embedding module
128 Template uploading module
13 Database
2 User
21 Duet video creator
211 Duet video Creator device
212 Creator clip
22 Template creator
221 Template creator device
23 Advertiser
231 Advertiser device
24 Invitee
241 Invitee device
242 Invitee clip
3 Duet video
3A Duet video A
3B Duet video B
3C Duet video C
31 Right duet clip
32 Left duet clip
33 Duet video audio
34 Duet video creating button
35 Duet video sharing button
4 Duet template
41 Right template clip
411 Right template clip selection button
412 Right template clip importing interface
42 Left template clip
421 Left template clip selection button
422 Left template clip importing interface
43 Template audio
44 Create Template button
45 Template creating interface
46 Template creating button
47 Template uploading button
51 Demo clip
52 Counterpart clip
53 Recording window
6 Ad
61 Ad importing interface
7 Duet video display on other platform
8 Invitation button
81 Right template clip invitee selecting button
82 Left template clip invitee selecting button
83 Invitation interface
84 Invitation sending button
85 Invitee clip creating button
86 Invitee clip sending button
87 Invitation duet video
9 Sponsor button
91 Sponsor interface
92 Sponsor ad importing interface
93 Sponsor ad embedding button

### DETAILED DESCRIPTION OF PREFERRED EMBODIMENT

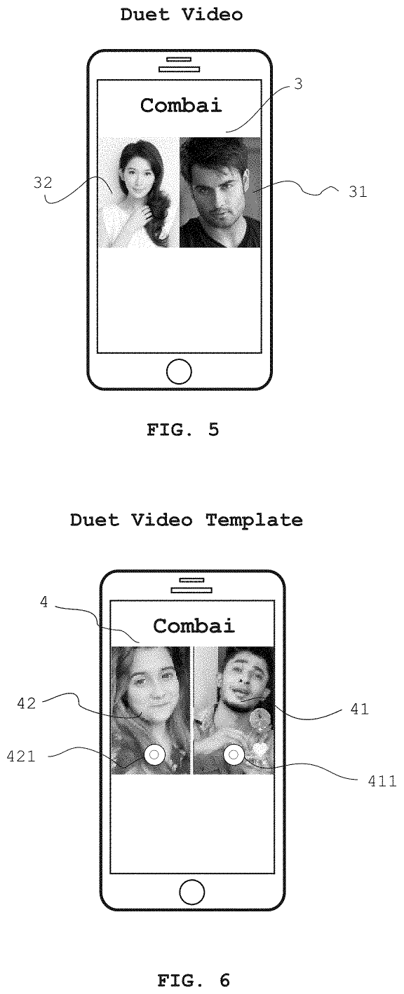

A duet video in the present invention is formed by combining two duet clips side by side. As illustrated in FIG. 5, a duet video 3 is formed by combining a right duet clip 31 with a left duet clip 32 side by side, right duet clip 31 and left duet clip 32 having the same time length and the same duet video audio.

A duet template 4 is a duet video demo used by duet video creators to start creating duet videos. As illustrated in FIG. 6, duet template 4 having a right template clip 41 and a left template clip 42, these two template clips are placed side by side, right template clip 41 and left template clip 42 having the same time length and the same template audio 43. Each duet template 4 having a template ID, the associated right template clip 41 having the same template ID with a right position, the associated left template clip 42 having the same template ID with a left position. Right template clip 41 having an associated right template clip selection button 411, left template clip 42 having an associated left template clip selection button 421, such that if a creator tap right template clip selection button 411 to select to act as right template clip 41, the created creator clip will have the same template ID and a right position, if the creator tap left template clip selection button 421 to select to act as left template clip 42, the created creator clip will have the same template ID and a left position.

The present invention provides two methods for a creator to create a duet video:

Method #1—Creator using right template clip selection button 411 or left template clip selection button 421 to start creating a duet video.

Method #2—Creator using template invitation button 44 to start creating an invitation duet video with selected person.

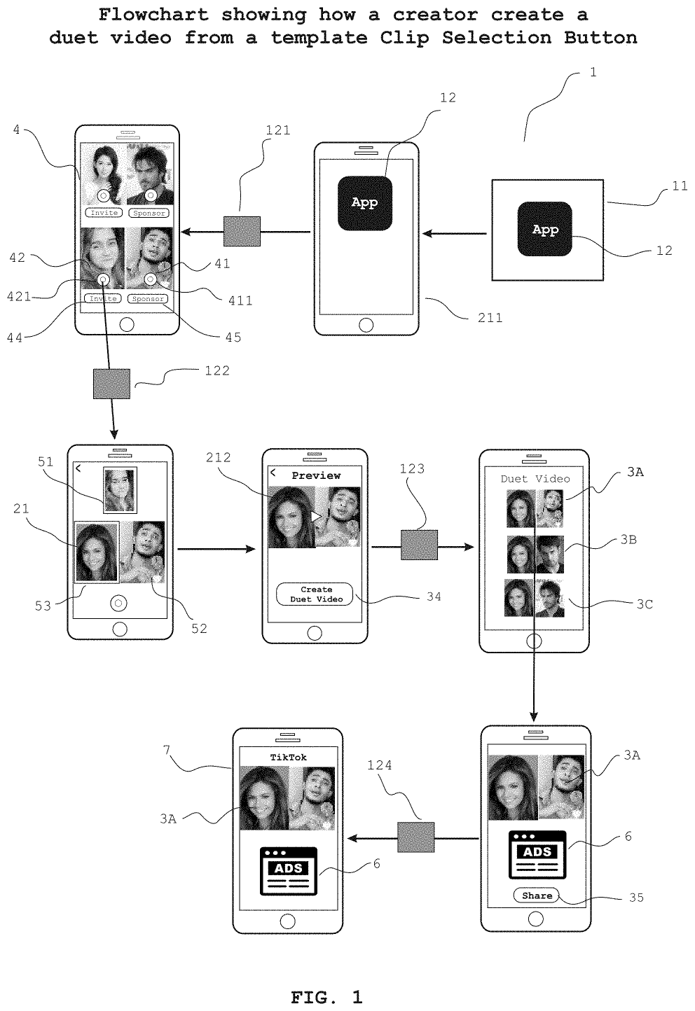

FIG. 1 illustrates duet video creating method #1, in which a duet video creator 21 tap left template clip selection button 421 to act as left template clip 42 and create duet video 3A, 3D, and 3C.

As illustrated in FIG. 1, system 1 mainly comprising at least one creator's digital device 211, a duet video app 12 and a database 13. Duet video app 12 further comprising a template displaying module 121, a duet clip creating module 122, a duet video creating module 123, a duet video sharing module 124, an invitation duet video creating module 125, a template creating module 126, a sponsor ad embedding module 127, and a template uploading module 128.

As illustrated in FIG. 1, duet video creator 21 wants to use app 12 to create a duet video, creator 21 first download app 12 from server 11 to creator's device 211, then open duet template displaying module 121 to display a queue of duet templates on creator's device 211 for creator 21 to selects. As illustrated in FIG. 1, creator 21 selects a template 4 and want to act as left template clip 42, by tapping left template clip selection button 421, app 12 open duet clip creating module 122 and go to a camera screen, on the camera screen, a demo clip 51, a counterpart clip 52 and a recording window 53 will appear on the camera screen, since creator 21 selects to act as left template clip 42, left template clip 42 is then used as demo clip 51, and right template clip 41 is then used as counterpart clip 52, and the recording image of creator 21 will appear in recording window 53. Creator 21 records a creator duet clip 212 similar to demo clip 51, creator duet clip 212 having the same template ID, position, time length, etc. of demo clip 51. Creator 21 has the option to use template audio 43 or use his or her own audio. Other than recording, creator 21 can also import creator duet clip 212 from a library. After creator duet clip 212 is created, tapping create duet video button 34 will start duet video creating module 123 to combine creator duet clip 212 with all the right template clips 42 that having the same template ID, as illustrated in FIG. 1, duet video 3A, 33 and 3C are created, duet video 3A, 3B and 3C come with an ad 6 that is previously embedded to duet template 4. Tapping the image of duet video 3A will open a screen to display duet video 3A, ad 6 and a share button 34. Tapping share button 34 will start duet video sharing module 124 to share duet video 3A and embedded ad 6 to other video or social platforms.

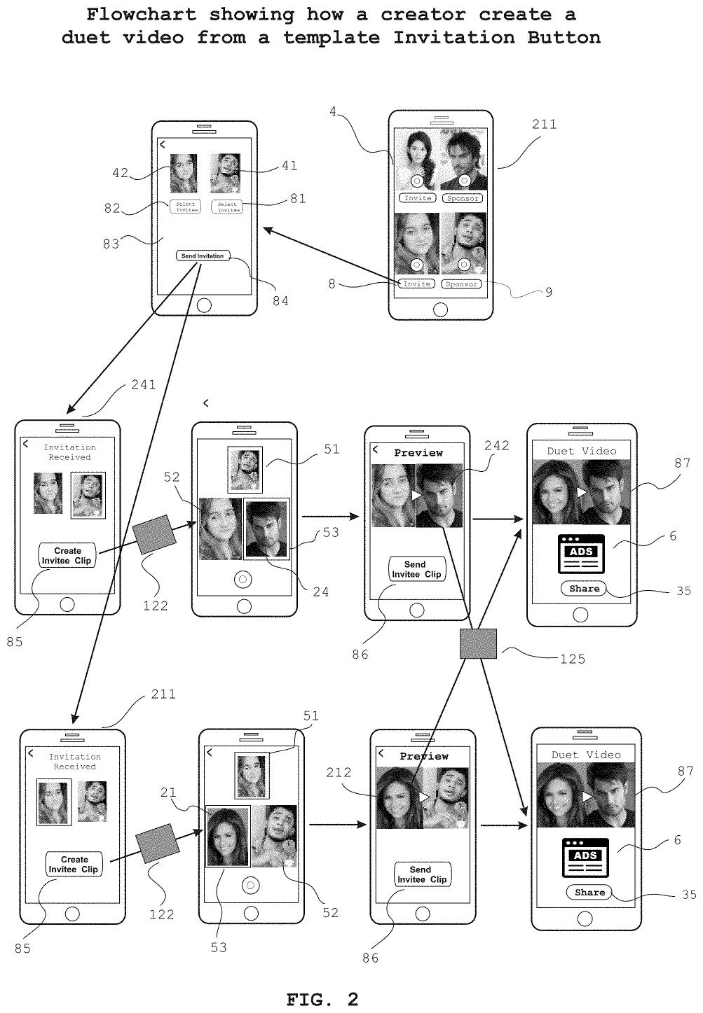

FIG. 2 illustrates duet video creating method #2, in which duet video creator 21 tap template invitation button 44 to create invitation duet video 442 with invitee 24.

As illustrated in FIG. 2, Creator 21 selects a duet template and wants to duet with a selected person, by tapping invitation button 8 associated with this template, an invitation interface 83 is opened and display right template clip 41, right template clip invitee selecting button 81, left template clip 42, left template clip invitee selecting button 82, and invitation sending button 84. Creator 21 tap right template clip invitee selecting button 81 to select invitees to act as right template clip 41, and tap left template clip invitee selecting button 82 to select invitees to act as left template clip 42. As illustrated in FIG. 2, creator 21 select herself as invitee for left template clip 42, and select invitee 24 for right template clip 41. After all invitees are selected, tapping invitation sending button 84 will send an invitation to invitee 24 device 241 and creator device 211, after receiving the invitation, invitee can open the invitation and tap an invitee clip creating button 85 to start duet clip creating module 122 to create invitee duet clip 242 and 212, invitee can send the created invitee duet clip to invitation duet video creating module 125 by tapping and invitee clip sending button 86, after the right invitee clip 242 and left invitee clip 212 are received, invitation duet video creating module 125 will automatically combine right invitee clip 242 with left invitee clip 212 to form an invitation duet video 87 and send it to all invitee's device.

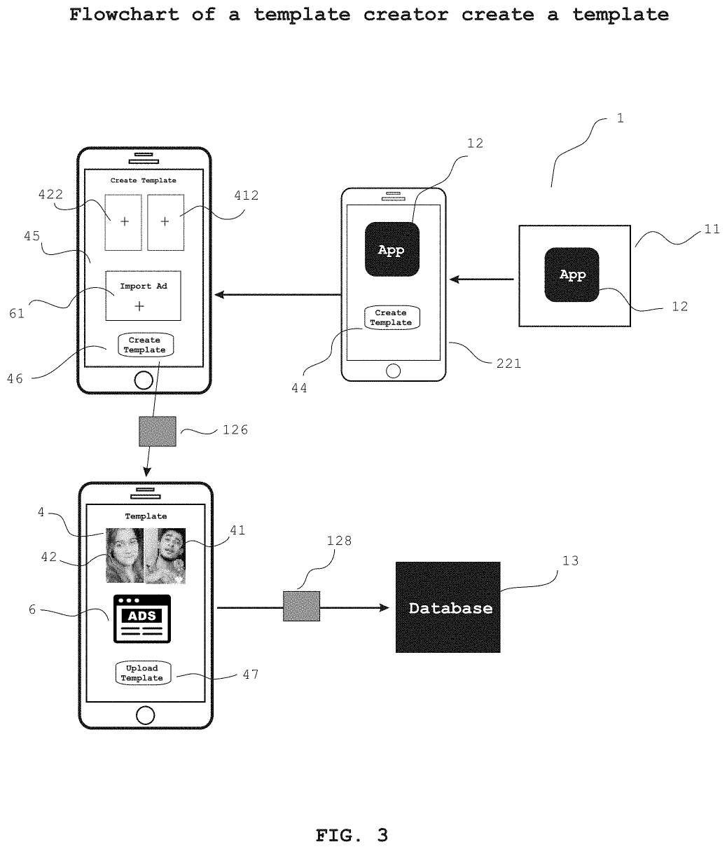

FIG. 3, illustrates how a template creator 22 create a template with embedded ad. Template creator 22 first download app 12 from server 11 to template creator's device 221, and then tap template creating button 44 to open template creating interface 45, template creating interface 45 displays a right template clip importing interface 412, a left template clip importing interface 422, and an ad importing interface 61. Template creator 22 then use right template clip importing interface 412 to import at least one right template clip 41, use left template clip importing interface 422 to import at least one left template clip 42, and use ad importing interface 61 to import ad 6 to app 12, after right template clip 41, left template clip 42 and ad 6 are imported, template creator 22 can tap template creating button 46 to start template creating module 126 to create template 4 with embedded ad 6, and tap template uploading button 47 to start template uploading module 128 to upload template 4 and embedded ad 6 to database 13.

The present invention allows a template creator 22 to upload multiple right template clips, multiple left template clips and multiple ads with the same template ID to the system, such that a duet video creator 21 can receive multiple duet videos by creating only one creator duet clip from a template.

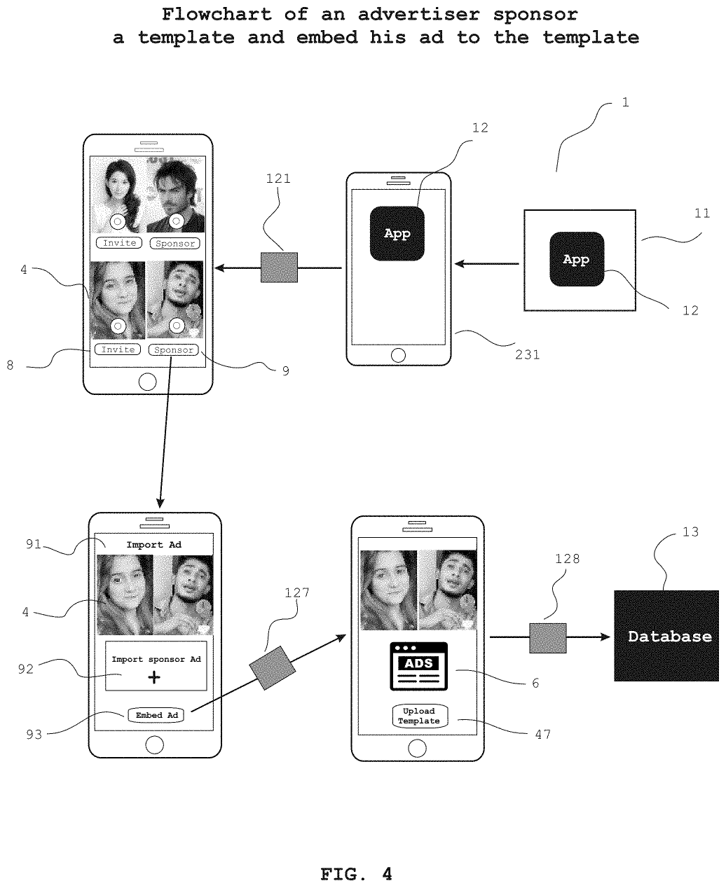

FIG. 4, illustrates how an advertiser 23 sponsor a template and embed his or her ad to the template. Advertiser 23 first download app 12 from server 11 to advertiser's device 231, open template displaying module 121 to display a queue of templates, after selecting a particular template that meet his or her needs, advertiser 23 tap the associated sponsor button 9 to open sponsor interface 91, sponsor interface 91 displays the selected template and a sponsor ad importing interface 92, sponsor 23 then use sponsor ad importing interface 92 to import ad 6 to app 12, after ad 6 is imported, advertiser 23 tap template embedding button 93 to start ad embedding module 127 to embed ad 6 to template 4, after review template 4 and embedded ad 6, advertiser 23 tap template uploading button 47 to start template uploading module 128 to upload template 4 with embedded ad 6 to database 13.

The present invention allows multiple advertisers to sponsor one template.

Other than sponsor a duet template, the present invention allows an advertiser to use the same method to sponsor a single video clip and embed ad to that video clip, such that all duvet videos created with this video clip will carry the same ad, such that the embedded ad can be shared together with these duet videos to other video or social platforms.

Having thus disclosed a number of preferred embodiments of the present invention, it being understood that numerous modifications and additions are contemplated and will now be apparent to those having benefit of the above disclosure,

What claimed is:

1. A system comprising at least one digital device, a duet video application, and a database; said digital device is capable of installing said duet video application from a server, operating said duet video application, communicating with said database via a network, recording and processing a video; said database is capable of storing all the data of said system; said duet video application is a software program that provides duet templates for duet video creators to create duet videos;
said duet template is formed by combining a right template clip and a left template clip side by side, said right template clip and said left template clip having the same time length and same audio, said duet template has an ID, said right template clip having the same ID of said template with a right position, said left template clip having the same ID of said template with a left position, said right template clip having an associated right template clip selection button, said left template clip having an associated left template clip selection button; such that a duet video creator can use said right template clip selection button to select to act as said right template clip, or use said left template clip selection button to select to act as said left template clip;
said duet video application comprising a duet template displaying module, a duet clip creating module and a duet video creating module, said duet template displaying module is a software program capable of displaying a queue of duet templates on said digital devices, said duet clip creating module is a software program capable of allowing said duet video creator to create duet clip based on selected duet template, said duet video creating module is a software program capable of combining said duet clip with a right template clip or a left template clip to from a duet video;

2. The duet clip creating module in claim 1 comprising a camera screen, said camera screen appear when said right template clip selection button or said left template clip selection button is tapped, said camera screen displays a demo clip, a counterpart clip, a recording window and a recording button; said demo clip is the same template clip selected by said duet video creator, said counterpart clip is the template clip not selected by said duet video creator, said recording window is a recording viewing window;
wherein said duet video creator can begin to record a duet clip by tapping said recording button, the recording time length is the same as the time length of said selected duet template, such that by referring to said demo clip and react to said counterpart clip, a duet clip that similar to said demo clip can be easily created by said duet video creator;
wherein said duet video creator can use said camera screen to import a video clip from other source as a duet clip;

3. The duet video creating module in claim 1 is a software program capable of automatically combining said duet clip with template clips that having the same template ID but having opposite position side by side to form at least one duet video;

4. The duet template in claim 1 comprising an associated invitation button, the duet video application in claim 1 having an invitation duet video creating module, said invitation duet video creating module is a software program capable of allowing said duet video creator to invite selected invitee to create an invitation duet video together; said invitation duet video creating module comprising an invitation creating interface and an invitation duet video creating program;
Wherein when a creator select a duet template and tap said invitation button associated with said selected duet template, said invitation creating interface appear and displays the right template clip and left template clip of said selected duet template, there is a right template clip invitee selecting button associated with said right template clip, there is a left template clip invitee selecting button associated with said left template clip;
wherein said creator can tap said right template clip invitee selecting button to select invitees to act as said right template clip, and tap said left template clip invitee selecting button to select invitees to act as said left template clip;
wherein said creator can send an invitation to all invitees by tapping an invitation sending button;
wherein after receiving an invitation, said invitee can tap an invitee duet clip creating button to open said camera screen to create invitee duet clip, right invitee duet clips are created by invitees who receive invitation for right duet template clip, left invitee duet clips are created by invitees who receive invitation for left duet template clip;
wherein said invitee can send said created invitee duet clip to said invitation duet video creating program by tapping an invitee duet clip sending button;
wherein after said right invitee duet clip and left invitee duet clip are received, said invitation duet video creating program automatically combine said right invitee duet clips with said left invitee duet clips side by side to form at least one invitation duet video and send said invitation duet videos to said digital devices of said creator and invitee;

5. The duet template in claim 1 comprising an associated sponsor button, the duet video application in claim 1 having a sponsor ad embedding module, said sponsor ad embedding module is software program capable of allowing an advertiser to embed ad to selected duet template, such that a duet video created from said selected duet template will carry the same embedded ad, such that said embedded ad can be shared with said duet video to other video or social platforms; said sponsor ad embedding module comprising a sponsor ad importing interface and a sponsor ad embedding program;
Wherein when an advertiser select a template and tap the sponsor button associated. with said selected template, said sponsor ad importing interface appear and displays a sponsor ad importing interface and a sponsor ad embedding button;
Wherein said advertiser can use said sponsor ad importing interface to import his or her ad;
Wherein when said sponsor ad embedding button is tapped, said sponsor ad embedding program embed said imported ad to said selected template;
Wherein when said template uploading button is tapped, said selected template, together with said embedded ad, is uploaded to said database;

6. The duet video application in claim 1 comprising a duet template creating module, said duet template creating module is a software program capable of allowing a template creator to create duet templates with embedded ad; said duet template creating module comprising a template creating interface and a template creating program;
Wherein when a template creating button is tapped, said template creating interface appear and displays a right template clip importing interface, a left template clip importing interface, an ad importing interface, and a template creating button;
Wherein said template creator can use said right template clip importing interface to import at least one right template clip, use said left template clip importing interface to import at least one left template clip, and use said ad importing interface to import at least one ad if needed;
Wherein when said template creating button is tapped, said template creating program combine said right template clip with said left template clip to form a duet template, and embed said imported ad to said template;
Wherein when said template uploading button is tapped, said template, together with said embedded ad, is uploaded to said database;

7. The duet video application in claim 1 comprising a duet video sharing module, said duet video sharing module is a software program capable of allowing a duet video creator to share his or her duet videos, together with embedded ads, to other video or social platforms, said duet video sharing module display a duet video sharing button on each duet video or invitation duet video;
Wherein when said duet video sharing button is tapped, the associated duet video or invitation duet video, together with embedded ad, is shared to other video or social platforms selected by said duet video creator;

8. The sponsor button in claim 5 can be associated with a single video clip, the sponsor ad embedding module in claim 5 is capable of enabling an advertiser to embed ad to said video clip, such that all duvet videos created with said video clip will carry said embedded ad;
Wherein said embedded ad can be shared with said duet videos to other video or social platforms.
